(19) United States
(12) Patent Application Publication
(10) Pub. No.: US 2014/0250709 A1
(43) Pub. Date: Sep. 11, 2014

(54) DRYERS IN SERIES WITH IMPROVED THROUGHPUT

(71) Applicant: Gala Industries, Inc., Eagle Rock, VA (US)

(72) Inventors: Wade Wilson, Bedias, TX (US); John Linkenhoker, Eagle Rock, VA (US)

(73) Assignee: Gala Industries, Inc., Eagle Rock, VA (US)

(21) Appl. No.: 14/198,270

(22) Filed: Mar. 5, 2014

Related U.S. Application Data
(60) Provisional application No. 61/772,645, filed on Mar. 5, 2013.

(51) Int. Cl. F26B 17/12

(52) U.S. Cl. CPC F26B 17/122
USPC 34/58; 34/236; 34/165; 34/168

(57) ABSTRACT

Improved devices, systems, and methods for drying pellets in a pellet-fluid slurry are disclosed. The system can provide a desired moisture level and output rate for the dried pellets. The system can use two dryers in series to remove moisture from the pellets in the pellet-fluid slurry. The two dryers can be connected with a transport pipe. The transport pipe can include a diverter valve to bypass the second dryer when desired. The transport pipe can also include a blower and/or heater to aid in the transport and drying of the pellets. The first dryer, the second dryer, or both can include a defluidizing section. The first dryer can be located at a higher level than the second dryer to facilitate movement of pellets from the first dryer to the second dryer.

### CROSS-REFERENCE TO RELATED APPLICATIONS AND PRIORITY CLAIM

This application claims priority under 35 U.S.C. §119(e) to, and the benefit of, U.S. Provisional Patent Application No. 61/772,645, of the same title, filed Mar. 5, 2013 which is hereby incorporated by reference as if set forth below in its entirety.

### BACKGROUND

1. Field

Embodiments of the present invention relate generally to a dryer system and a method of drying in series, and more particularly to a dryer system that has improved drying ability over conventional dryer systems.

2. Description of Related Art

Slurry streams comprising particulates suspended in a transport fluid are found in many industries. For example, the manufacturing of polymeric pellet materials typically involves extruding raw, melted polymeric material, cutting the extruded polymeric material into pellets, quenching those pellets in a cooling fluid, and subsequently transporting the pellet-fluid stream for additional processing. In other cases, there may be no extrusion and/or pelletization steps, but rather a recycling step comprising recycling and/or reclamation lines. In this configuration, the equipment upstream can be, for example, grinding equipment (e.g., to grind plastic into flakes or particles), followed by one or more washing and/or rinsing machines. The additional processing steps may include, but are not limited to, the removal of undesirable materials via an agglomerate catcher, defluidizing to remove some of the transport fluid from the slurry, and/or drying the pellets to remove moisture (e.g., surface moisture) from the pellets.

The pellet material and surface configuration of the pellet can influence the time and method used for drying the pellet. Pellets with a rough surface, for example, tend to retain moisture because of fractures, cracks, and/or openings on the surfaces of the pellet, which tends to make them more difficult to dry. These pellets are often referred to as having “melt fracture” or “shark skin” and may be the result of polymer chemistry. In other words, the chemistry may be such that the polymer has, for example, an increased sensitivity to friction and/or a reduction of flowability during the extrusion process.

Similarly, smaller pellets, pellets processed at lower temperatures, pellets with tacky surfaces, and hygroscopic pellets, for example, also tend to be difficult to dry. In many applications, the flow rate of the pellets during manufacture may also be very fast, which makes drying the pellets more difficult because they simply travel quickly through the dryer system. For a rotary dryer, for example, the rotor speed (i.e., the tip speed of the dryer's rotor), for example, may be high and, therefore, the time during which the pellets are in the dryer is relatively short. This time may be on the order of seconds, for example, as opposed to minutes or hours in conventional drying systems.

There are various prior art methods used to dry pellets to achieve a desired dryness level, while still maintaining a relatively high flow rate. Some prior art methods attempt to split the flow of a pellet-fluid slurry stream, for example, before it enters the drying unit. In this way, two separate streams enter two separate dryers, respectively, and are dried concurrently. It is logical that if a dryer receives fewer pellets, then the dryer can dry the pellets more efficiently and effectively. This split-flow method presents problems, however, at least because it is difficult to uniformly split the flow of the stream.

It is therefore an objective of the present invention to provide an alternative method for drying pellets to a desired moisture level, while still maintaining a desired flow rate.

### SUMMARY

Embodiments of the present invention relate generally to a serial drying system and method, and more specifically to a series dryer for efficiently drying a material that is wet, damp, or suspended in a slurry and moving at relatively high flow rates. Embodiments of the present invention relate to material processing equipment for manufacturing, recycling, washing, and/or drying a number of pelletized, ground, or granular materials that are wet, damp, or in a slurry. Specifically, embodiments of the present invention can reduce moisture levels on or in materials that are typically difficult to dry, including, for example, materials with melt fracture, shark skin, and/or fibrous surfaces, tacky materials, soft materials, materials which are processed at low end slurry temperatures, and materials such as small pellets or micropellets which have very little mass (and therefore low impact energy during drying) and a large surface (and therefore more area to dry) at a given flow rate.

Embodiments of the present invention can comprise a system for drying granular material comprising a first dryer, a second dryer, and a transport pipe disposed between the first dryer and the second dryer. In some embodiments, the granular material can travel in a first direction from the first dryer to the second dryer via the transport pipe. In some embodiments, one or more of the first dryer and the second dryer can comprise a defluidizing section.

In some embodiments, the first dryer and/or the second dryer can comprise centrifugal dryers. In some embodiments, the transport pipe can be disposed between the first dryer and the second dryer at an angle of between approximately 30 degrees and 90 degrees from horizontal, or more specifically at an angle of between approximately 45 degrees and 75 degrees from horizontal. The system can also comprise a transport blower for providing airflow in the transport pipe in the first direction and/or in a second direction that is opposite the first direction. In some embodiments, the transport pipe can also comprise a diverter valve with a first position and a second position. In this configuration, the granular material can travel in the first direction from the first dryer to the second dryer when the diverter valve is in the first position and can travel in a second direction, and bypasses the second dryer, when the diverter valve is in the second position. In some embodiments, the second dryer can comprise a round inlet to prevent the granular material from sticking to the second inlet. Moreover, in some embodiments, the transport pipe can be round to prevent the granular material from sticking to the sidewalls of the transport pipe.

Embodiments of the present invention can also comprise a system for drying granular materials comprising a first dryer disposed at a first height, a second dryer disposed at a second height, and a transport pipe disposed between the first dryer and the second dryer. In some embodiments, the first height is higher than the second height. So, for example, in some embodiments, the first dryer can be disposed on a first floor and the second dryer is disposed on a second floor (i.e., where the first floor is higher than the second floor).

The system can also comprise a blower for providing airflow in a second direction (i.e., opposite the first direction). In some embodiments, the airflow from the blower can be heated. The airflow can be heated, for example and not limitation, by steam, a natural gas, propane, butane, or an electric heat source.

Embodiments of the present invention can also comprise a system for drying granular materials comprising a first dryer disposed at a first height, a second dryer disposed at a second height, a transport pipe disposed between the first dryer and the second dryer, and a controller for controlling the operation of one or more of the first dryer and the second dryer. In this configuration, the first dryer and the second dryer can be centrifugal dryers, for example, and the controller can individually control the rotor speed in the first dryer and the rotor speed in the second dryer. In other embodiments, the system can also comprise a transport blower for providing airflow in the first direction or a second direction (which can be opposite the first direction) and the controller can control the direction and speed of the blower. In some embodiments, because the pellets are substantially drier leaving the first dryer in some instances, only the first dryer may include a defluidizing section.

These and other objects, features, and advantages of the present invention will become more apparent upon reading the following specification in conjunction with the accompanying drawings.

### BRIEF DESCRIPTION OF THE FIGURES

FIG. 1a illustrates a side view of an exemplary first dryer and a second dryer in series, in accordance with some embodiments of the present invention.

FIG. 1b illustrates a top view of an exemplary first dryer and a second dryer in series, in accordance with some embodiments of the present invention.

FIG. 2b illustrates a side view of an exemplary first dryer and a second dryer in series having an auger screw component, in accordance with some embodiments of the present invention.

FIG. 2b illustrates a top view of an exemplary first dryer and a second dryer in series having an auger screw component, in accordance with some embodiments of the present invention.

FIG. 3a illustrates a side view of an exemplary first dryer and a second dryer in series having a blower component, in accordance with some embodiments of the present invention.

FIG. 3b illustrates a top view of an exemplary first dryer and a second dryer in series having a blower component, in accordance with some embodiments of the present invention.

FIG. 4a illustrates a side view of an exemplary first dryer and a second dryer in series, wherein the first dryer and second dryer are vertically offset from each other, in accordance with some embodiments of the present invention.

FIG. 4b illustrates a top view of an exemplary first dryer and a second dryer in series, wherein the first dryer and second dryer are vertically offset from each other, in accordance with some embodiments of the present invention.

FIG. 4c illustrates an alternative side view of an exemplary first dryer and a second dryer in series, wherein the first dryer and second dryer are vertically offset from each other, in accordance with some embodiments of the present invention.

FIG. 5a illustrates a side view of an exemplary first dryer and a second dryer in series, wherein the first dryer and second dryer are vertically in line with each other, in accordance with some embodiments of the present invention.

FIG. 5b illustrates a top view of an exemplary first dryer and a second dryer in series, wherein the first dryer and second dryer are vertically in line with each other, in accordance with some embodiments of the present invention.

FIG. 5c illustrates an alternative side view of an exemplary first dryer and a second dryer in series, wherein the first dryer and second dryer are vertically in line with each other, in accordance with some embodiments of the present invention.

FIG. 6 depicts a system with series dryers and a controller, in accordance with some embodiments of the present invention.

### DETAILED DESCRIPTION

Embodiments of the present invention relate generally to a serial drying system and method, and more specifically to a series dryer for efficiently drying a material that is wet, damp, and/or suspended in a slurry and moving at relatively high speeds and/or flow rates. Embodiments of the present invention relate to material processing equipment for manufacturing, recycling, washing, and/or drying a number of pelletized, ground, or granular materials that are wet, damp, and/or suspended in a slurry. Specifically, embodiments of the present invention can provide an effective system and method for drying materials that are moving quickly and are typically difficult to dry.

To simplify and clarify explanation, the system is described below as a system for drying pelletized, or otherwise granular materials, such as polymer, rubber materials, adhesive, asphalt, and/or bitumen, for example and not limitation. One skilled in the art will recognize, however, that the invention is not so limited. The system can also be deployed for drying many materials that are processed or manufactured using excess fluids including, but not limited to, a carrier fluid or a slurry. In other words, the system can be used for most materials that are processed in bulk and require some drying before packaging or further processing. This could include, for example and not limitation, particulate matter such as polymers, rubbers, adhesives, asphalt, and/or bitumen, or foods such as grains and beans.

The materials described hereinafter as making up the various elements of the present invention are intended to be illustrative and not restrictive. Many suitable materials that would perform the same or a similar function as the materials described herein are intended to be embraced within the scope of the invention. Such other materials not described herein can include, but are not limited to, materials that are developed after the time of the development of the invention, for example. Any dimensions listed in the various drawings are for illustrative purposes only and are not intended to be limiting. Other dimensions and proportions are contemplated and intended to be included within the scope of the invention.

Although preferred embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise. References to a composition or fluid containing “an” ingredient or “a” constituent is intended to include other ingredients or other constituents, respectively, in addition to the one named.

The term “pellet” used herein, for example, can include, and be interchangeable with, micropellets or particulates. Such pellets/micropellets/particulates can be a variety of shapes, and is typified by regular or irregular shaped discrete particles without limitation on their dimensions, including flake, stars, spheres, cylindrical pellets, lenticular or disc-shaped pellets, chopped fibers, rubber crumb pellets, and/or other shapes. They also can be round, square, rectangular, triangular, pentagonal, hexagonal or otherwise geometric in cross-section, star-shaped or other decorative designs, and can be the same or different when viewed in a second cross-section perpendicularly to the first. It shall also be understood that the pellets do not have to be solid pieces, but may include particles defining openings or hollow shapes. Additionally, the pellets may include expanding agents, foaming agents, or volatiles which may be partially or wholly expanded to produce low (or lower) bulk density particles.

The pellets can comprise many materials including, but not limited to, polyethylene materials such as linear low density polyethylene (LLDPE), low density polyethylene (LDPE), medium density polyethylene (MDPE), and high density polyethylene (HDPE), polypropylenes, polyesters, polyamides, styrenic materials such as PS, ABS, and SAN, thermoplastic elastomers such as TPU, EPDM, and TPO, polycarbonates, PMMA, EVA, vinyls, plasticized and non-plasticized PVC, polyolefins, adhesives, asphalts and/or bitumen. In addition, these materials can cover a range of molecular weights, crystallinity, hardness, etc., which are in the solid phase upon entering and exiting the dryer and irrespective of color, additives, fillers, clarity, and/or degree of transparency or opaqueness.

The term “fluid” can include many fluids including, but not limited to, water and water with one or more additives, other liquids, and/or gases including but not limited to those disclosed, described, and claimed in U.S. Pat. Nos. 7,157,032, 8,361,364, 8,366,428, 8,007,701, and 8,011,912, and U.S. Publication No. 2012/0228794, all of which are hereby incorporated by reference.

The terms “comprising,” “containing,” or “including” indicate that at least the named compound, element, particle, or method step is present in the composition or article or method, but does not exclude the presence of additional compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Embodiments of the present invention can comprise a method for drying pellets in a pellet-fluid slurry to achieve a desired moisture, output, and flow rate of dried pellets. Specifically, embodiments of the present invention utilize at least two dryers in series to reduce surface moisture from the pellets in a pellet-fluid slurry to achieve a desired surface moisture level. In some embodiments, the method can provide pellet output at a flow rate ranging from approximately 65 to 70 tons per hour.

As mentioned above, a problem with conventional dryer systems is their inability to sufficiently dry particular materials, especially when the materials are moving quickly through the systems. To address this issue, conventional systems have used a variety of methods. In one example, the slurry/pellet output is divided into two dryers in parallel. In this manner, the output required by each dryer is theoretically halved. Problems exist, however, with efficiently dividing the flow between the two dryers, among other things. These problems arise because of unsteady/uneven particle flow rates and undesirable machine layout, among other things. In another example, a dryer is simply built taller than existing dryers. This can be advantageous because increasing the dryer height can yield higher levels of moisture reduction at a greater efficiency than increasing the diameter of the dryer. However, building tall dryers presents several manufacturing and operational difficulties. For example, increasing the size of the center shaft of rotary dryers can cause the shaft to become unstable or wobble during operation due to, among other things, difficulties balancing the taller shaft. Moreover, manufacturing facilities (both for manufacturing the dryers and for operating the dryers) may not have sufficiently high ceilings to accommodate taller dryers. It is also more difficult to access the internal components of taller dryers and to ship taller dryers to purchasers.

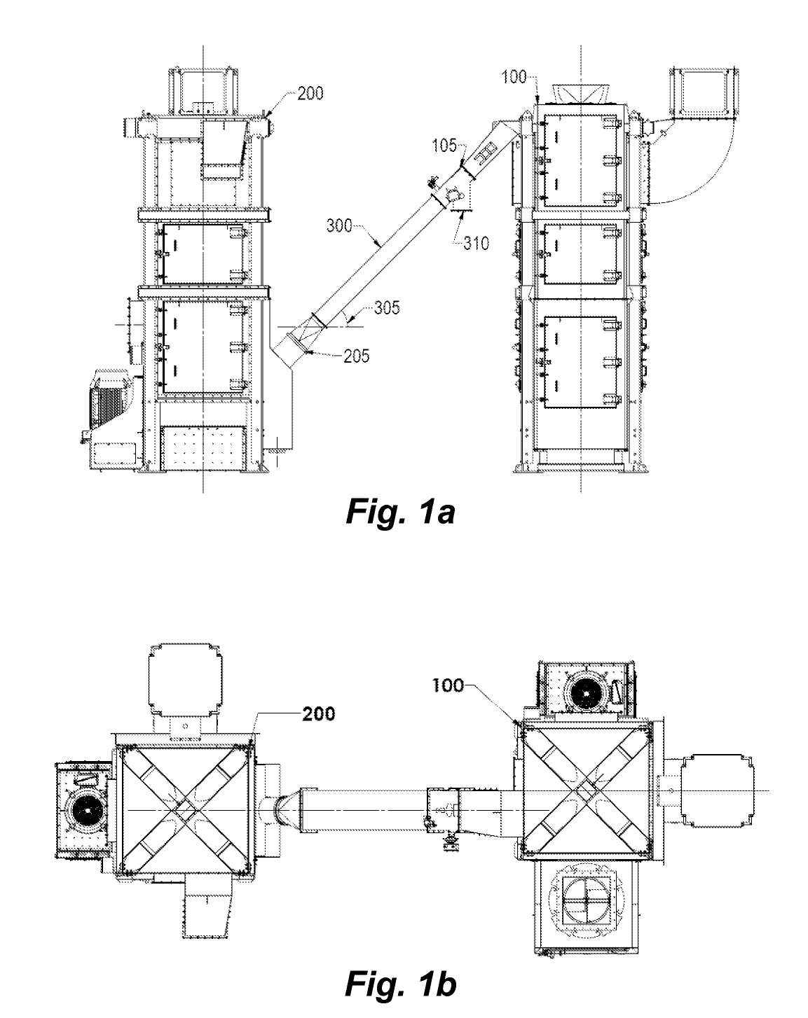

To address these issues, embodiments of the present invention relate to a drying system comprising two or more dryers in series. FIGS. 1a and 1b depict a side view and a top view, respectively, of an exemplary embodiment of a first dryer 100 and a second dryer 200 in series. As described above, after pellets are formed from a melted raw material and quenched in a cooling fluid to set the material, for example, they are generally transported to a dryer system to remove some or all of the moisture from the pellets. In some embodiments, various intermediate steps may also take place between the extrusion and drying steps including, for example and not limitation, pelletizing, pellet conditioning, agglomerate catching, and preliminary dewatering. A discussion of some of these intermediate steps and a general overview of the drying process are discussed in U.S. Pat. No. 8,205,350, entitled “Dryer System with Improved Throughput,” which is incorporated herein by reference in its entirety as if fully set forth below.

Logically, the pellets contain more moisture when they enter the first dryer 100 in the series than when the pellets enter the second dryer 200. As a result, in some embodiments, the first dryer 100 can comprise both a defluidizing section and a drying section. In some embodiments, the defluidizing section may be attached to, or integrated with, the drying section. In other embodiments, the defluidizing section may be separate and isolated from the drying section. In still other embodiments, the system can include a separate defluidizing section and a defluidizing section integrated into the first dryer 100.

In some embodiments the defluidizing section (also sometimes referred to as a “dewatering section”) may be upstream from the drying section of the first dryer 100. The dewatering section can comprise a plurality of components. The dewatering section can comprise, for example, a housing comprising a plurality of baffle plates configured to remove water, and/or a screen adapted to retain the pellets in the main pellet flow path and allow water to pass through. An exemplary dewatering system is described in more detail in U.S. Pat. No. 8,205,350, which is hereby incorporated by reference in its entirety as if fully set forth below.

It should be noted that the dewatering section typically does not remove all of the fluid from the pellet/fluid slurry. This can be because the dewatering section is simply not designed for this purpose or because the fluid can actually serve as a lubricant for the pellets. In this manner, the additional fluid can prevent the pellets from sticking together or sticking to equipment, for example, during their transport. In some cases, the fluid may also aid in conveying the pellets from one component to another by minimizing friction and/or surface tension between the pellets and the drying equipment.

After the pellets leave the dewatering section, they can be transported into the drying section of the first dryer 100. An exemplary dryer is also described in U.S. Pat. No. 8,205,350, mentioned above. Generally, the first dryer 100 can comprise one or more rotors that cause the pellets to travel outward and repeatedly hit screens that enclose and surround the rotor(s), thereby centrifugally removing the fluid (i.e., by allowing it to pass through the screens). As the fluid is being removed, the pellets can also be pushed up through the dryer 100 and away from the fluid removal sections. In some embodiments, a heated or non-heated air source may also be applied to the pellets. In some embodiments, the air source can be heated with the heat provided by, for example and not limitation, a steam heat source, a gas heat source, or an electric heat source. In some embodiments, each type of heat source can comprise a heat exchanger, such as a radiator, for example, to impart heat to the air. In some embodiments, the gas heat source can be, for example, natural gas, propane, or butane. In some embodiments, the air source can be applied in a direction opposite the travel of the pellets, which can minimize the moisture and humidity coming out of the first dryer 100 with the pellets as the pellets are discharged. This configuration enables the first dryer 100 to output slightly “damp” pellets at a first dryer output 105, which can then be transported to the second dryer 200 for additional drying.

In some embodiments, the second dryer 200 can receive the damp pellets from the first dryer output 105 at a second dryer input 205. The second dryer 200 may be configured substantially similar to the first dryer 100 or may be a different design. In addition, while the second dryer 200 can include a dewatering section, because the pellets have been partially dried by the first dryer 100, in many cases an additional dewatering section is not necessary.

As before, the second dryer 200 can comprise a rotor that causes the pellets to repeatedly hit screens, which enclose or surround the rotating rotor, thereby removing some or all of the fluid remaining on the pellets from the first dryer 100. As with the first dryer 100, as the additional fluid is removed, the pellets can be pushed up and away from the fluid removal sections of the drier 200. Also as before, an air source may be applied to the pellets to minimize the moisture and humidity that is blown out with the pellets as the pellets are discharged from the second dryer 200. This can be done with an exhaust blower, for example and not limitation. In this configuration, the second dryer 200 can output substantially dry pellets, which can then undergo additional processing steps, including but not limited to, bagging, sorting, classifying, or packaging.

In some embodiments, the first dryer 100 and the second dryer 200 can be rotary dryers. More specifically, the first dryer 100 and the second dryer 200 can be centrifugal dryers, as described above.

In some embodiments, a transport pipe 300 can transfer the pellets from the first dryer output 105 to the second dryer input 205. As previously described, a substantial amount of fluid is removed from the pellets in the first dryer 100, which, in some cases, can make it more difficult to transport the pellets from the first dryer 100 to the second dryer 200. In addition, the surface tension and/or friction of the pellets exiting the first dryer between the interior walls of the transport pipe 300 can also impede the flow of the pellets. To this end, as illustrated in FIG. 1a, in some embodiments, the second dryer input 205 can be rounded to facilitate the transport of the pellets. Moreover, in some embodiments, the transport pipe 300 can be rounded to prevent the granular material from sticking to the sidewalls of the transport pipe.

In other words, because the pellets are still at least partially damp when they leave the first dryer 100, they may be somewhat tacky. As a result, the pellets tend to stick to flat surfaces more readily than rounded surfaces. Thus, the rounded input 205 of the second dryer 200 and transport pipe 300 can minimize sticking between the damp pellets and the input 205 and or transport pipe 300 surface. Additionally, the transport pipe 300 can also be disposed at a downward angle between the first dryer output 105 to the second dryer input 205 to facilitate the transport of pellets. In some embodiments, the angle 305 of the transport pipe 300 connecting the first dryer output 105 and the second dryer input 205 can be between approximately 30° and 90° below horizontal. In some embodiments, the angle 305 of the transport pipe 300 can be at least 45° with respect to horizontal.

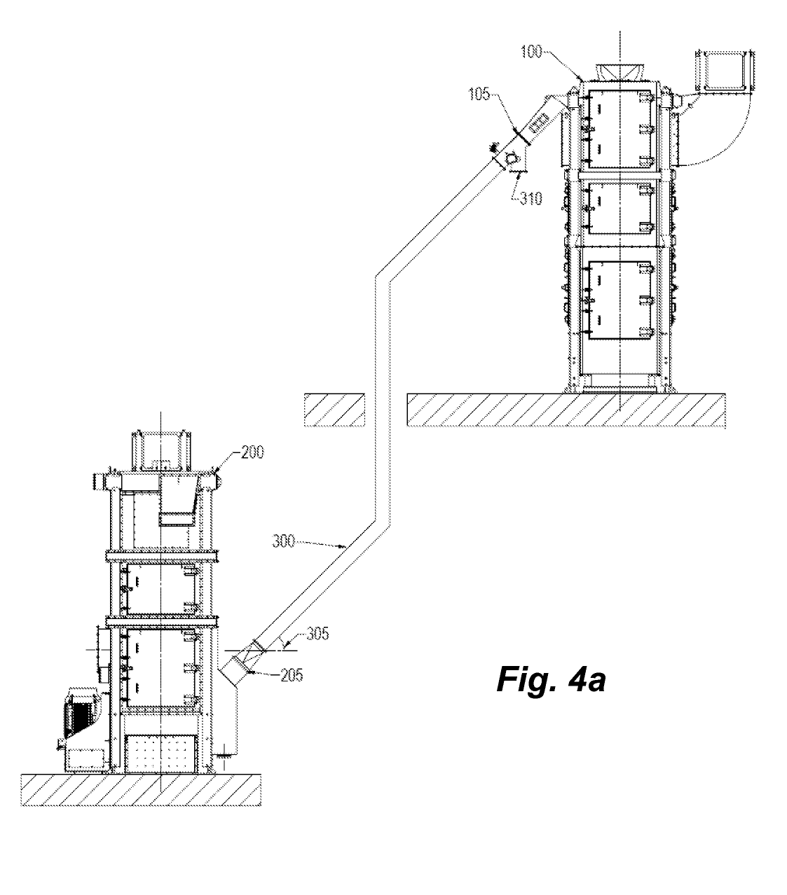

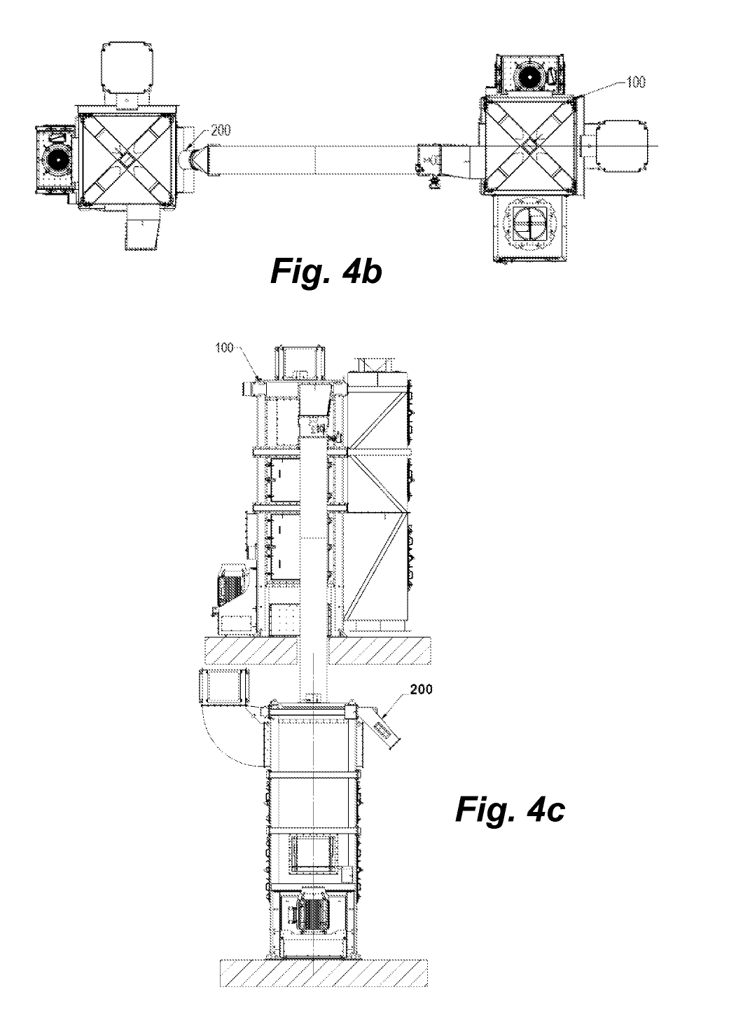

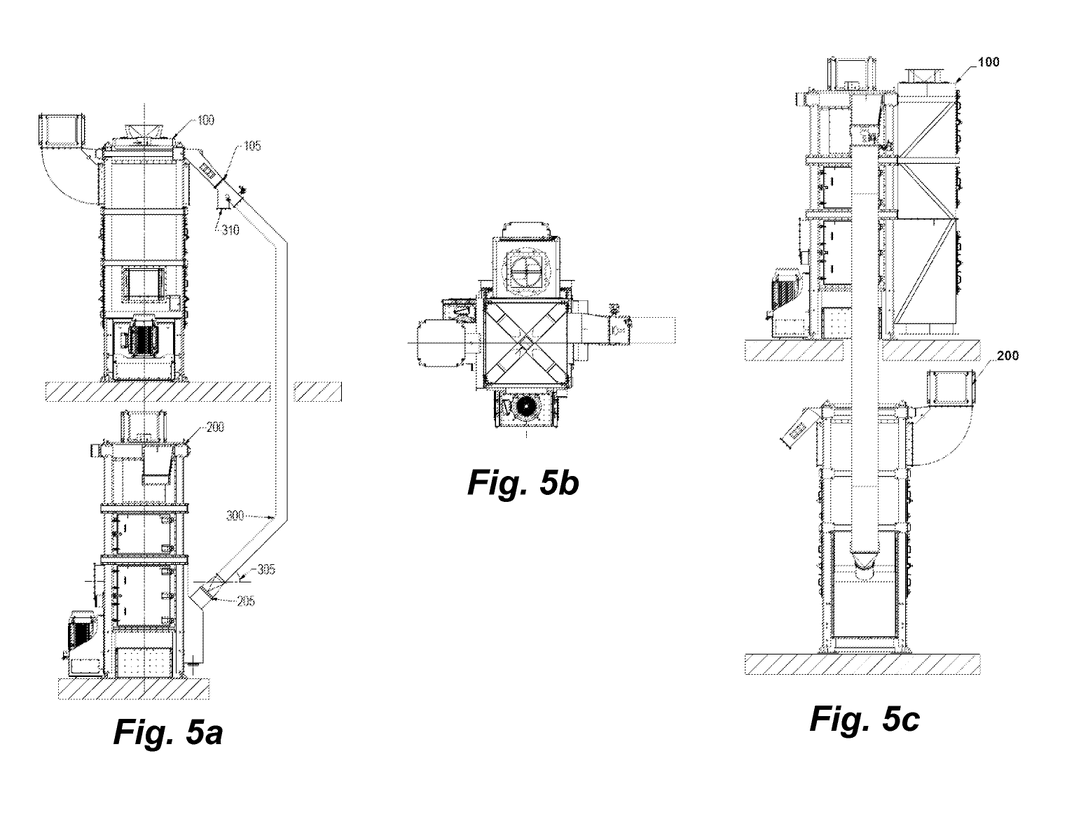

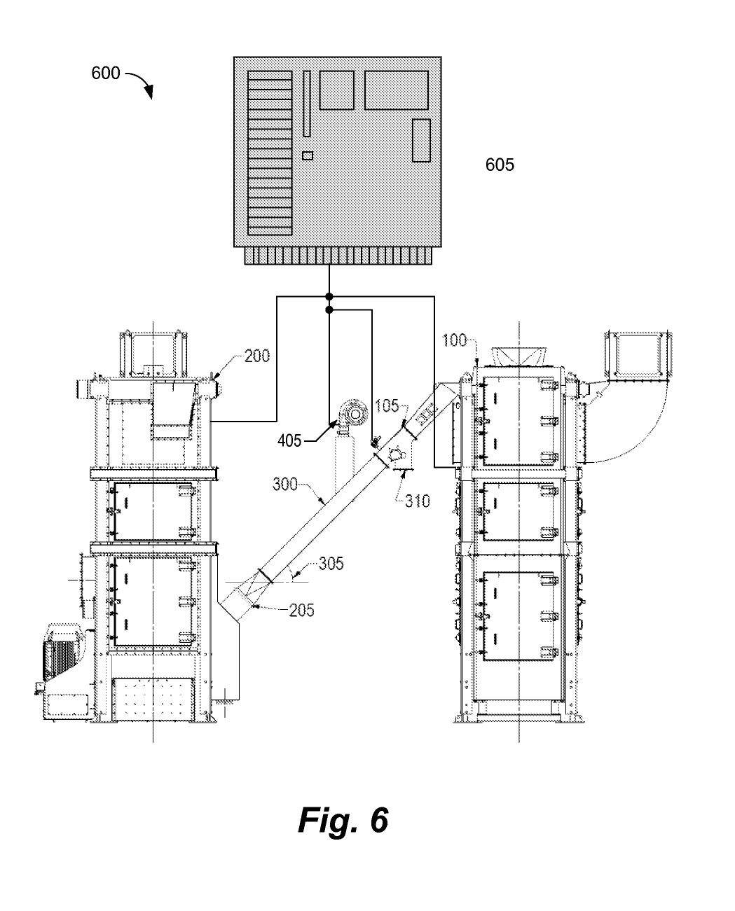

In some embodiments, as shown in FIGS. 4a-c and 5a-c, the first and second dryers 100, 200 can be vertically offset. In some embodiments, as shown, the first and second dryers 100, 200 can be on different floors. In other embodiments, the first dryer 100 can be on a pedestal, ramp, or platform above the second dryer 200. In some embodiments, the first dryer 100 can be located on an upper, or second, floor and the second dryer 200 can be located on a lower, or first, floor. Of course, one of skill in the art will recognize that the number of floors separating the dryers 100, 200 is immaterial provided the first dryer 100 is somewhat above the second dryer 200. In other words, the first dryer 100 could be located several feet above the second dryer (e.g., on a platform or loading dock) or several floors above the second dryer 200. In some embodiments, therefore, depending on the distance between the dryers 100, 200, a plurality of transport pipe angles ranging from about 30° to about 90° between the first and second dryers can be used.

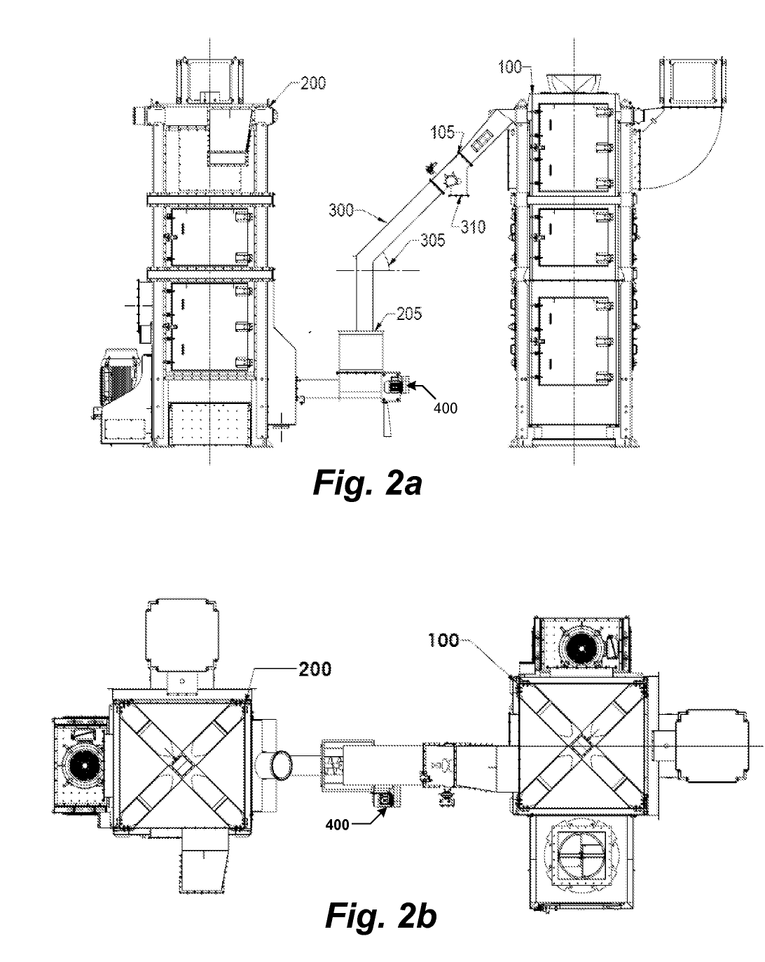

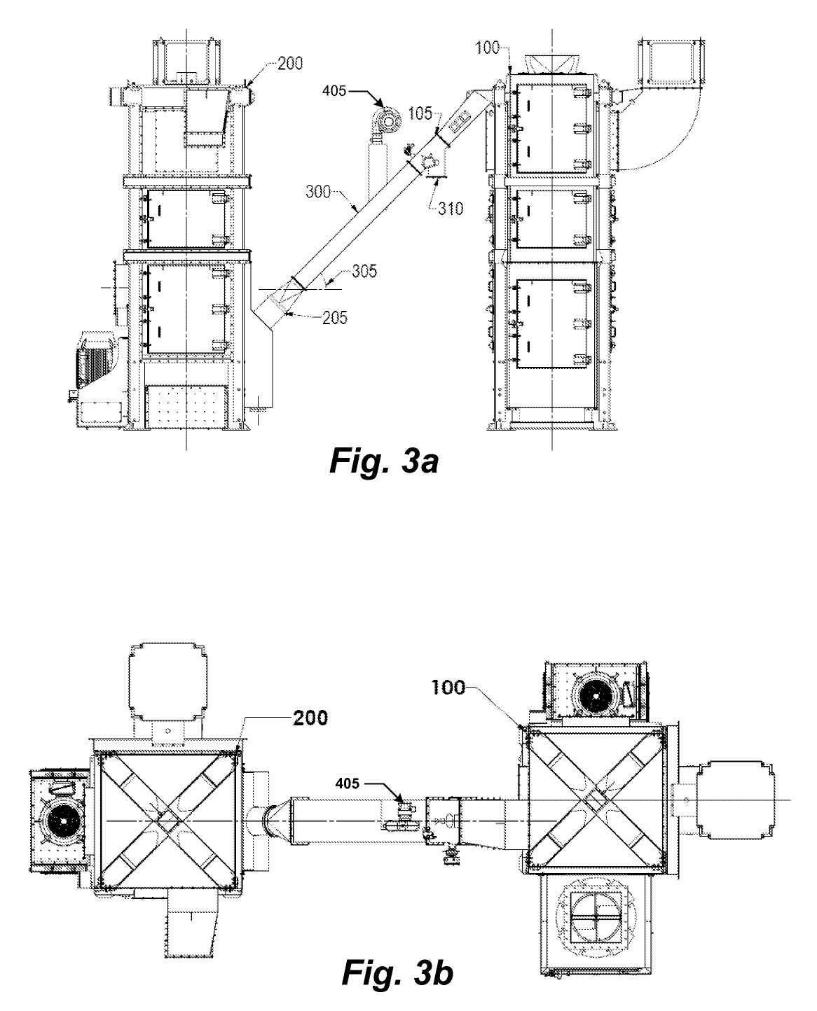

In some embodiments, one or more additional components may be attached to or incorporated within the transport pipe 300 to assist in the transport of pellets from the first dryer output 105 to the second dryer input 205. In some embodiments, an auger screw 400 (FIGS. 2a and 2b) and/or a transport blower 405 (FIGS. 3a and 3b), for example, can be attached proximate the transport pipe 300. In other embodiments, additional fluids or gases, as described above, can be incorporated into the transport pipe to aid in the transport of pellets from the first dryer output 105 to the second dryer input 205.

In still other embodiments, a diverter valve 310 may also be incorporated into the transport pipe 300, for example, to redirect pellets away from the second dryer 200. In some embodiments, the pellets can be redirected to a different component, for example, if the pellets are deemed sufficiently dry and do not need to be sent to the second dryer 200. When the second dryer 200 can be bypassed, the system can conserve energy and reduce wear and tear on the second dryer 200 and the material. Further, in some embodiment, the system can include a rotary lock feature (not illustrated) disposed within the transport pipe 300 to enable the system to, for example and not limitation, feed, meter, gas lock, and/or isolate the two dryers. This can be useful, for example, if countercurrent airflows, pressures, and/or temperatures need to be isolated between the first dryer 100 and the second dryer 200.

One skilled in the art will recognize that the first dryer 100, second dryer 200, and transport pipe 300 can be individually configurable to achieve a desired moisture reduction for a specific material at a desired output rate. In some embodiments, the moisture reduction can also be adjusted depending on any subsequent processing of the pellets. So, for example, if the pellets are to be bagged, the system can be set to reduce the moisture content significantly, at or close to zero. If the pellets will coated or dusted with powder subsequent to drying, on the other hand, it can be desirable for some moisture to remain in the pellets to aid in powder adhesion. If the pellet material is LLDPE and/or HDPE, then the desired final moisture content for bagging after the second dryer 200, for example, can be approximately 0.05%. One skilled in the art will recognize, however, that embodiments of the present invention can be tailored to specific pellet materials, moisture reduction specifications, and pellet output rates. Different moisture levels can be achieved, for example and not limitation, by changing the throughput rate, rotor speed, air flow, or temperature in the dryers 100, 200. Of course, different moisture levels, or desired moisture levels, can also be achieved by employing dryers 100, 200 of appropriate size.

Embodiments of the present invention are not limited to a first dryer and a second dryer, however. Embodiments of the present invention can also comprise a second and third dryer, for example, in parallel with each other that are each in series with first dryer. Further, the dryers of the present invention may be identical in internal configuration, substantially similar in internal configuration, or substantially dissimilar in internal configuration. In addition, the external configuration of the dryers may be customized to address a particular user's needs such as, for example, space and power constraints in a particular manufacturing or processing facility. In some embodiments, for example, access doors, input and output chutes, and other components may be positioned at a location suitable for the user. Further, the dryers may be of the same capacity or of different capacities. In some embodiments, the first and second dryers can be centrifugal-type dryers; however, other types of dryers can also be used and are contemplated herein.

Embodiments of the present invention can also comprise a system 600 for drying pellets comprising a first dryer 100, and second dryer 200, and a controller 605. In some embodiments, the dryers 100, 200 can be centrifugal dryers, for example, and the controller 605 can control the speed of the rotors in the dryers 100, 200. In other embodiments, the system can also comprise a transport blower 405. The transport blower 405 can be used to assist in the transportation of the pellets, or can be used to assist in drying the pellets. As a result, in some situations, the transport blower 405 can be operated to blow in a first direction (i.e., from the first dryer 100 to the second dryer 200) to facilitate the movement of the pellets from the first dryer 100 to the second dryer 200; and, in other situations, the transport blower 405 can be operated to blow in a second direction (i.e., against the flow of the pellets from the first dryer 100 to the second dryer 200) to separate fluid from the pellets and assist in drying the pellets. In this configuration, the controller 605 can control the direction and speed of the transport blower 405. The system 600 can also comprise a diverter valve 310 located in the transport pipe 300.

In a first position, the diverter valve 310 can enable the pellets to flow from the first dryer 100 to the second dryer 200. In a second position, the diverter valve 310 can enable the pellets to bypass the second dryer 200 and exit the system 600, or continue on for additional processing (e.g., dusting with powder). In between the first position and the second position, the diverter valve 310 can divert a portion of the pellets around the second dryer 200. In some embodiments, the controller 605 can control the position of the diverter valve 310.

The controller 605 can be a variety of electronic devices programmable to control the various functions of the system 600, such as the transport blower 405, diverter valve 310, first dryer 100, and second dryer 200. In some embodiments, the controller 605 can be a microcontroller with, for example, programmable or pre-programmed (e.g., application specific integrates circuits (ASICs)). In other embodiments, the controller 605 can be a PC, server, mainframe, or other computer programmed to control the system 600. In still other embodiments, the controller can include an application (or, app) on a smartphone or tablet. The controller 605 can be connected to the system using, for example and not limitation, a direct wired connection, a local area network (LAN), an internet connection, a wireless connection, or a cellular or radio connection. In some embodiments, the controller 605 can also be networked via a similar connection to enable remote operation and control.

While several possible embodiments are disclosed above, embodiments of the present invention are not so limited. For instance, while several possible dryers, outlets, and connectors are described above, other suitable components, materials, and layouts could be selected without departing from the spirit of the invention. In addition, the location and configuration used for various features of embodiments of the present invention can be varied according to a particular factory, manufacturing facility, or processor that requires a slight variation due to, for example, the materials used and/or space or power constraints. Such changes are intended to be embraced within the scope of the invention.

The specific configurations, choice of materials, and the size and shape of various elements can be varied according to particular design specifications or constraints requiring a device, system, or method constructed according to the principles of the invention. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A system for drying granular material comprising:
a first dryer;
a second dryer; and
a transport pipe disposed between the first dryer and the second dryer;
wherein the granular material travels in a first direction from the first dryer to the second dryer via the transport pipe.

2. The system of claim 1, wherein one or more of the first dryer and the second dryer comprise a defluidizing section.

3. The system of claim 1, wherein one or more of the first dryer and the second dryer comprise centrifugal dryers.

4. The system of claim 1, wherein the transport pipe is disposed between the first dryer and the second dryer at an angle of between approximately 30 degrees and 90 degrees from horizontal.

5. The system of claim 1, wherein the transport pipe is disposed between the first dryer and the second dryer at an angle of between approximately 45 degrees and 75 degrees from horizontal.

6. The system of claim 1, further comprising a transport blower providing airflow in the transportation pipe in the first direction.

7. The system of claim 1, the transport pipe further comprising a diverter valve with a first position and a second position;
wherein the granular material travels in the first direction from the first dryer to the second dryer when the diverter valve is in the first position; and
wherein the granular material travels in a second direction, and bypasses the second dryer, when the diverter valve is in the second position.

8. The system of claim 1, wherein the second dryer comprises an inlet; and
wherein the inlet is round to prevent the granular material from sticking to the second inlet.

9. A system for drying granular materials comprising:
a first dryer disposed at a first height;
a second dryer disposed at a second height; and
a transport pipe disposed between the first dryer and the second dryer;
wherein the granular material travels in a first direction from the first dryer to the second dryer via the transport pipe; and
wherein the first height is higher than the second height.

10. The system of claim 9, wherein the first dryer is disposed on a first floor and the second dryer is disposed on a second floor; and
wherein the first floor is higher than the second floor.

11. The system of claim 9, further comprising:
a blower providing an airflow in a second direction;
wherein the second direction is opposite the first direction.

12. The system of claim 11, wherein the airflow from the blower is heated.

13. The system of claim 12, wherein the airflow is heated by a one or more of a propane heat source and a natural gas heat source.

14. The system of claim 12, wherein the airflow is heated by a steam heat source.

15. The system of claim 12, wherein the airflow is heated by an electric heat source.

16. A system for drying granular materials comprising:
a first dryer disposed at a first height;
a second dryer disposed at a second height;
a transport pipe disposed between the first dryer and the second dryer; and
a controller for controlling the operation of one or more of the first dryer and the second dryer;
wherein the granular material travels in a first direction from the first dryer to the second dryer via the transport pipe; and
wherein the first height is higher than the second height.

17. The system of claim 16, wherein the first dryer and the second dryer are rotary dryers; and
wherein the controller individually controls a first rotor speed in the first dryer and a second rotor speed in the second dryer.

18. The system of claim 17, further comprising:
a transport blower providing an airflow in the first direction or a second direction;
wherein the controller controls the direction and speed of the blower; and
wherein the second direction is opposite the first direction.

19. The system of claim 16, wherein only the first dryer comprises a defluidizing section.

20. The system of claim 16, the transport pipe further comprising a diverter valve with a first position and a second position;
wherein the granular material travels in a first direction from the first dryer to the second dryer when the diverter valve is in the first position; and
wherein the granular material travels in a second direction, and bypasses the second dryer, when the diverter valve is in the second position.
